(19) United States
(12) Patent Application Publication
(10) Pub. No.: US 2010/0266488 A1
(43) Pub. Date: Oct. 21, 2010

(54) HYDROGEN STORAGE MATERIAL MADE FROM MAGNESIUM HYDRIDE

(75) Inventors: Patricia De Rango, Gieres (FR); Albin Chaise, Fontaine (FR); Daniel Fruchart, Echirolles (FR); Salvatore Miraglia, Grenoble (FR); Regis Olives, Cabestany (FR)

Correspondence Address: YOUNG & THOMPSON, 209 Madison Street, Suite 500, Alexandria, VA, 22314, US

(73) Assignee: UNIVERSITE JOSEPH FOURIER, Grenoble (FR)

(21) Appl. No.: 12/746,993

(22) PCT Filed: Dec. 10, 2008
(86) PCT No.: PCT/FR08/52264

§ 371 Date: Jun. 9, 2010

(30) Foreign Application Priority Data
Dec. 10, 2007 (FR) 07 59689

(51) Int. Cl. C01B 3/02; C01B 31/08

(52) U.S. Cl. 423/648.1; 502/417

(57) ABSTRACT

A compacted material includes magnesium hydride and expanded natural graphite and a method for preparing such a material including the steps which consist in: (i) mixing a magnesium hydride or powdered magnesium with a powdered graphite; and (ii) shaping the mixture by compaction. It also proposes the use of the material for hydrogen storage and a method for hydrogen storage and release from storage including the steps which consist in: (a) introducing the material into a suitable hydrogen tank; (b) placing the material under hydrogen pressure in pressure and temperature conditions that enable the hydrogen to be absorbed by the material; and (c) desorbing the hydrogen from the material in pressure and temperature conditions permitting the desorption of the material.

The present invention relates to materials used for the reversible storage of hydrogen. More particularly, the present invention relates to a compact composite material based on magnesium hydride for hydrogen storage and a method for its preparation.

Hydrogen is used in numerous industrial fields, in particular as fuel (for example in heat engines or fuel cells), or as a reagent (for example for hydrogenation reactions). Within this framework, taking into account its volume in the gaseous state and its explosiveness, it is desirable for hydrogen to be stored in a form which provides reduced bulk and safety containment.

One possibility consists in storing hydrogen in the form of metallic hydrides. In this case, the hydrogen to be stored is brought into contact with a metal or a metallic alloy in pressure and temperature conditions which induce incorporation of the hydrogen in atomic form in the crystal lattice (absorption reaction or charge reaction). In order to recover the hydrogen thus stored, conditions of lower pressure and/or higher temperature are employed, which facilitate the reverse reaction (desorption reaction or discharge reaction). A “reversible storage capacity” may be determined, expressed in percentage by mass, which corresponds to the maximum amount of hydrogen which the storage material can discharge once it has been charged. For more details concerning the storage of hydrogen in the form of hydride, reference may be made to “Hydrogen in Intermetallic Compounds I and II”, L. Schlapbach, Springer Verlag (1998).

Magnesium hydride constitutes a particularly advantageous choice of hydride. It has a high hydrogen storage capacity (7.6% by mass) and a volumetric density comparable to that of liquid hydrogen. Furthermore, it is plentiful, inexpensive and completely recyclable. In addition, magnesium is more stable than conventional ternary hydrides such as LaNi₅, or Laves phase, which tend to decompose gradually during cycling under hydrogen, thus reducing the storage capacity.

A. Rodriguez Sanchez (Int. J. Hydrogen Energy 28, (2003, 515) reports on the use of expanded graphite as heat transfer matrix in beds of metallic hydrides (nickel hydrides LaNi₅Hₓ and titaniferous iron ore hydrides), in particular for hydrogen storage.

However, there are significant differences between the metallic hydrides such as those described by A. Rodriguez Sanchez and magnesium hydride, which is a chemical hydride having an ionovalent semi-conductor behaviour. Metallic hydrides are basically insertion hydrides, the hydrogen atom occupies “small” interstitial sites (the average diameter of the interstitial sites is about 0.8 Å). These sites exist in the corresponding alloys or metals. The M-H bond is of a metallic character because the hydrogen bonding electrons of s character will contribute to the conduction band of the metal (the metal is characterised by electronic conduction). The “non-metallic” or ionocovalent hydrides are basically semi-conductors. The valence band does not have an s character, but rather a p character. This bond has an ionic character. Typically, the compound Mg₂H₂ is a chemical hydride (ionocovalent, therefore metallic non-conductor). This is not an insertion hydride: while magnesium metal has a hexagonal structure, the compound MgH₂ has a cubic structure. The bonds between “metal” ions and the hydrogen ion are much greater.

This difference has practical consequences, since:
the hydriding temperature is at ambient temperature for metallic hydrides, while it is close to 300° C. for magnesium, and even more for other ionocovalent chemical hydrides.

Metallic hydrides are subject to the phenomenon of decrepitation after a certain number of hydrogen absorption/desorption cycles. Decrepitation is the phenomenon of size reduction to the scale of the metallic grain structure by fracturing which results from mechanical stresses induced during hydriding, by reason of the difference between the density of the metallic hydride and that of the metal. This decrepitation may be at the root of a drop in hydrogen absorption/desorption performance at the end of a certain number of cycles. This decrepitation phenomenon is not observed in the case of magnesium hydride. Magnesium is ductile and consequently accommodates more easily the mechanical stresses induced by hydriding. Numerous research projects are currently being carried out in order to optimise the performance of magnesium hydride for hydrogen storage.

However, the low thermal conductivity of the magnesium hydride powder, an ionocovalent non-metallic system, renders management of the thermal flows difficult. The hydriding reaction is strongly exothermic and it is advisable to evacuate rapidly the heat released, in order to charge the hydrogen within a reasonable time. On the other hand, the desorption reaction is strongly endothermic, and is spontaneously interrupted in the absence of a heat source.

Moreover, the hydriding of the magnesium is accompanied by a large increase in volume, of the order of 30%, thereby producing internal tensions and causing significant mechanical stresses on the walls of the tank.

Moreover, powdered magnesium hydride has a low storage volume capacity and is difficult to handle.

Important work has been done on improving the kinetics of absorption and desorption of hydrogen from MgH₂.

Thus, Patent Application WO 2007 125 253 A1 describes the activation of MgH₂ by co-grinding with an alloy of centred cubic structure based on titanium, vanadium and either chromium or manganese. The powders obtained exhibit very high performances in terms of hydrogen absorption and desorption kinetics, but are however very reactive and may burst into flame spontaneously in air.

The aim of the present invention is to propose a hydrogen storage material based on magnesium hydride which does not have the drawbacks mentioned, and in particular which is compact, can be handled without special precautions, and has good properties in terms of mechanical strength, thermal conductivity and hydrogen absorption and desorption kinetics.

According to the invention, this aim is achieved by a material comprising a mixture of magnesium hydride and graphite, preferably expanded natural graphite (ENG), in compacted form.

This material has a reduced porosity, which increases its hydrogen storage volume capacity. Its compact form imparts to it a mechanical strength which facilitates its handling.

Moreover, expanded natural graphite facilitates the cohesion of the material which has a radial thermal conductivity very superior to that of magnesium powder or magnesium hydride.

Finally, the composite can be handled in air without the risk of bursting into flames spontaneously, even when it has been prepared with activated magnesium hydride.

According to a first aspect, the invention proposes a compacted material comprising magnesium hydride and expanded natural graphite.

The term “magnesium hydride” as used here also covers, according to the step of the method, magnesium partially or completely charged with hydrogen.

The term “compacted material” as used here means a solid body in which the density is significantly greater than that of the respective divided raw materials. This material is obtained in particular by compression of the mixture of raw materials. Generally, the density will be at least 100% greater, but may be 400% greater, than that of the divided raw materials.

The term “transition metal” as used here refers to chemical elements which have in the atomic state a partially filled sub-layer d or which form at least one ion with a partially filled sub-layer d. Those particularly referred to are the transition metals V, Nb, Ti, Cr and Mn.

It is assumed that the material contains very little or no compounds resulting from a chemical reaction. It is rather a matter of a composite material constituted by a magnesium hydride powder (MgH₂) and by a “skeleton” formed by ENG in the form of flakes. As a result of the effect of the pressure, the flakes are aligned in the plane perpendicular to the compression axis.

Magnesium hydride may in particular be obtained by an incomplete hydriding reaction. Advantageously, the magnesium hydride powder used contains less than 10% by weight, preferably less than 5% by weight, of metallic magnesium. The more perfectly the magnesium hydride is hydrided, the more stable the powder will be with respect to air.

According to a preferred embodiment, the magnesium hydride is activated previously in order to have favourable hydrogen absorption and desorption kinetics. This activation may be effected in particular by co-grinding the magnesium hydride with a transition metal, an alloy of transition metals or a transition metal oxide, which are preferably introduced in proportions of between 1 and 10% atomic relative to the mixture, preferably about 5%.

Co-grinding of the magnesium hydride with the activating agent is carried out in the absence of the expanded natural graphite. Grinding the expanded natural graphite would have the effect of destroying the “skeleton” and the flakes of ENG. However, it is preferable for the structure of the ENG in the form of flakes to be preserved in order to impart to the final compacted material a strongly anisotropic character.

Particularly preferred is magnesium hydride activated according to the teaching of the application filed under number WO 2007 125 253 A1, by co-grinding with an alloy of centred cubic structure comprising titanium, vanadium and a transition metal selected from chromium and manganese, preferably introduced in proportions of between 1 and 10% atomic relative to the mixture.

The activated magnesium hydride is advantageously in the form of a very fine powder, having a grain size of between 1 and 10 μm. Each grain of powder is formed of a multitude of crystallites of about 10 to 20 nm. After co-grinding with the activating agent, the activated magnesium hydride thus has a structure on a nanometric scale which facilitates the diffusion of the hydrogen between the crystallites and which, associated with the effect of the activating agent, makes it possible to obtain very rapid hydrogen absorption/desorption kinetics.

The graphite, according to the invention, is an expanded natural graphite (ENG). Expanded natural graphite is a form of graphite modified by chemical and thermal treatments. Graphite is advantageous because it is hydrophobic, refractory and a good conductor of heat.

Expanded natural graphite is particularly effective because it is in the form of small flakes of millimetric size, which imparts to it a strongly anisotropic character, and which facilitates conduction of heat over long distances, on the scale of the grains of magnesium.

The ENG particles are advantageously in the form of elongate vermicules which have a diameter of the order of 500 μm and a length of a few millimetres.

As a result of the effect of uniaxial compaction, the vermicules are oriented substantially perpendicularly to the compression axis. This imparts to the composite material a strongly anisotropic thermal behaviour, and facilitates the conduction of heat perpendicularly to the compression axis.

The material according to the invention thus has a radial thermal conductivity greatly superior to that obtained with a fluidised bed of activated magnesium. This permits improved management of the thermal flows during the operation of exothermic hydriding, and therefore a great reduction in the hydrogen recharging time.

The proportion of expanded natural graphite in the composition described is not particularly limited. It has been demonstrated that the compacted material according to the invention is mechanically stable and may be machined, including with rates of ENG of 5% or less by weight, which is not the case with mixtures of metallic hydrides of the LaNi₅Hₓ type and titaniferous iron ore hydrides.

In addition, the compacted material according to the invention is homogeneous no matter what the proportion of ENG. The homogeneity results from a slight difference between the density of the hydride and that of the ENG. The ENG has a low density and the magnesium hydride activated by an activating agent (transition metal, an alloy of transition metals or a transition metal oxide) is very powdery following the co-grinding and as a result has an apparent density closer to that of ENG than that of the metallic hydrides. By way of example, the density of the activated magnesium hydride is about thirty times lower than that of LaNi₅Hₓ. Thus, the preparation of compact materials of LaNi₅Hₓ/ENG is very much more difficult and their homogeneity is more random.

The proportion of expanded natural graphite in the composition described will generally be selected according to the thermal conductivity desired for the final material. Its adjustment results from a compromise between increasing the thermal conductivity and the lowering of mass absorption capacity, the ENG not, a priori, absorbing any hydrogen chemically. A low content, of the order of from 1 to 10% by weight in relation to the final composition already makes it possible to increase the thermal conductivity significantly (see FIG. 5).

Advantageously, the composition according to the invention preferably comprises from 5 to 10% by weight of expanded natural graphite.

The material preferably comprises from 80 to 99% by weight of magnesium hydride.

According to a preferred embodiment, the material consists of magnesium hydride and ENG.

Preferably, the material is shaped by compaction.

The material will generally be brought into a form facilitating homogeneous compaction, for example in pellet form.

The material proposed is easy to manufacture, uses available raw materials, is inexpensive and does not require sophisticated equipment.

Also, according to a second aspect, the invention proposes a method for preparing a compacted material comprising magnesium hydride and expanded natural graphite, comprising the steps which consist in:
(i) mixing a magnesium hydride or powdered magnesium with an expanded natural graphite; and
(ii) shaping the mixture by compaction.

Preferably, the above preparation method includes, firstly, a supplementary step which consists in activating the magnesium hydride or powdered magnesium by co-grinding with an activating agent selected from a transition metal, a mixture of transition metals, a transition metal oxide and an alloy of transition metals. The method thus makes it possible to prepare a compacted material comprising activated magnesium hydride and expanded natural graphite.

The magnesium hydride used for the manufacture of the material is in the form of a powder, preferably having a grain size of between 1 and 10 μm.

The mixing of the powders may be carried out in a conventional manner, for example in a mixer. It is preferably performed at ambient temperature, and at atmospheric pressure.

The compaction of the mixture of powders is carried out preferably in the form of uniaxial compression, for example in a pelleting machine.

Advantageously, mixing and compaction are carried out in a controlled atmosphere, in particular when pyrophoric activated magnesium is used.

The force exerted during compaction is selected in particular according to the desired porosity of the material. By way of example, a compression force of the order of 1 t/cm² has proved suitable for obtaining pellets of material having a porosity of the order of 0.3.

Compaction makes it possible to increase the volumetric hydrogen storage density compared with a fluidised bed of magnesium hydride and to improve the mechanical strength. Furthermore, surprisingly, the material thus obtained is no longer pyrophoric and can therefore be handled more easily.

The shaped material may then be machined, in particular in order to have dimensions suited to the tank.

The other properties of the material relating to hydrogen storage, such as the hydrogen absorption and desorption kinetics, are not significantly affected by the shaping of the material.

The material described is easy to handle, even when it incorporates an activated magnesium hydride, and has an improved hydrogen storage volume capacity.

Also, according to a third aspect, the invention proposes the use of the material described for hydrogen storage.

According to a final aspect, the invention finally proposes a method for hydrogen storage and release from storage including the steps which consist in:
(a) introducing the aforementioned material into a suitable hydrogen tank;
(b) placing the material under hydrogen pressure in pressure and temperature conditions that enable the hydrogen to be absorbed by the material; and
(c) desorbing the hydrogen from the material in pressure and temperature conditions corresponding to the desorption of the material.

Advantageously, the energy released by charging with hydrogen is evacuated by a heat exchanger.

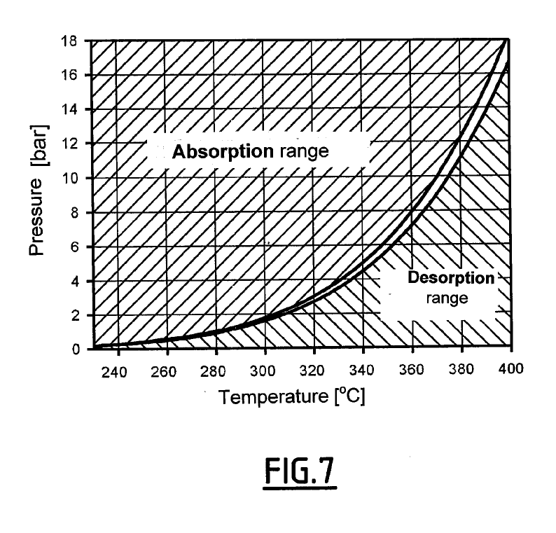

The pressure and temperature conditions may be easily determined from the equilibrium curve of the magnesium hydride (see FIG. 7).

The invention will be described in more detail by means of the following examples and the drawings, which show:

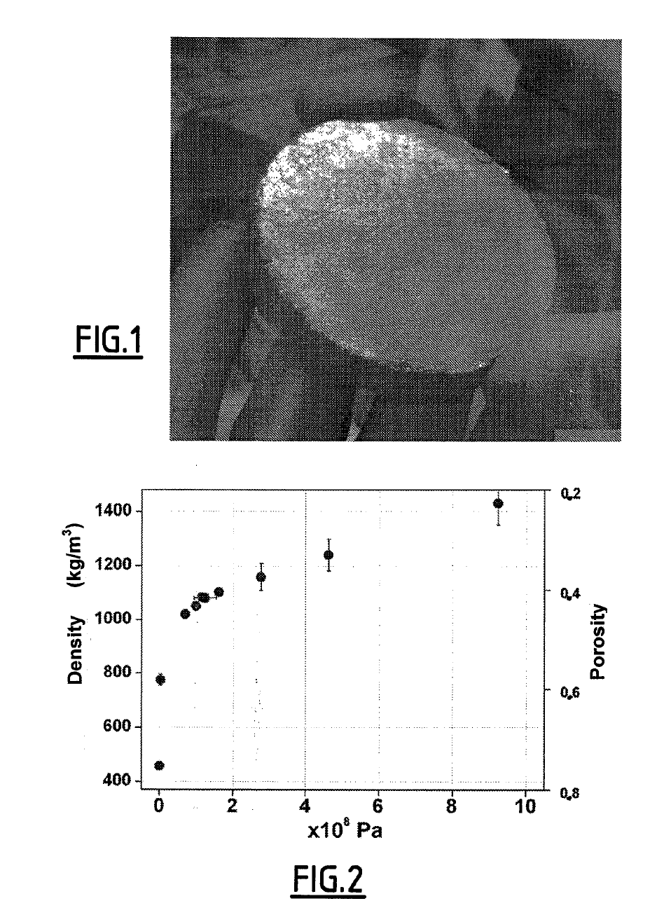

FIG. 1: a photograph of a pellet obtained according to Example 1;

FIG. 2: the measured density and the corresponding porosity of pellets according to Example 1 according to the compressive force applied;

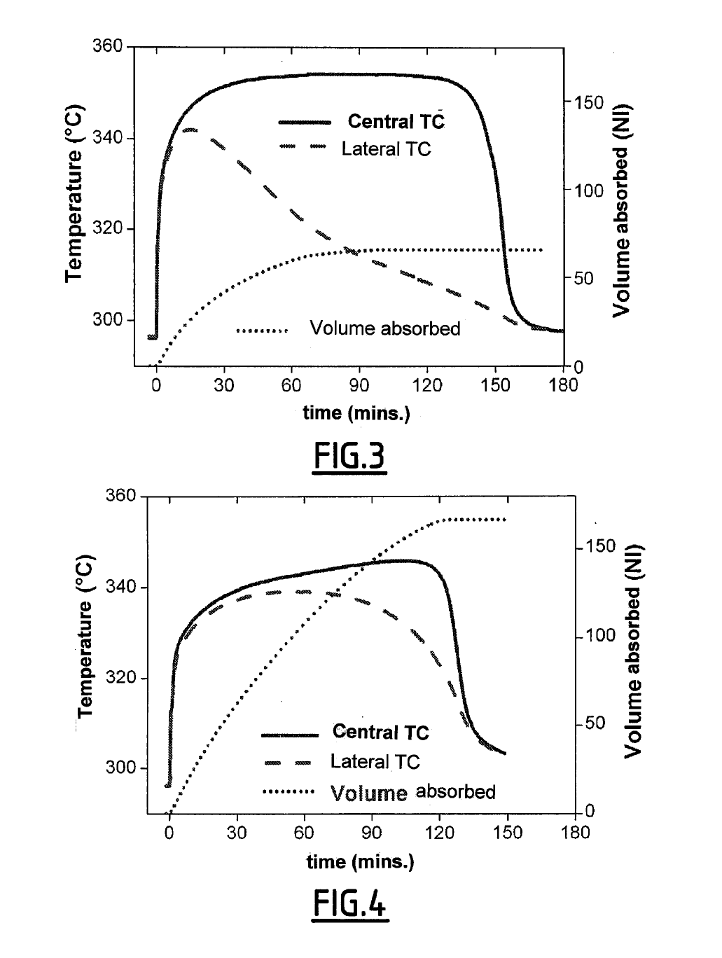

FIG. 3: the volume of hydrogen absorbed during the charging of the tank filled with MgH₂ powder and the temperature measured at the centre and at the periphery of the tank;

FIG. 4: the volume of hydrogen absorbed during the charging of the tank filled with pellets obtained according to Example 1 and the temperature measured at the centre and at the periphery of the tank;

FIG. 5: diagram of the measurement of the thermal conductivity according to the divided bar principle;

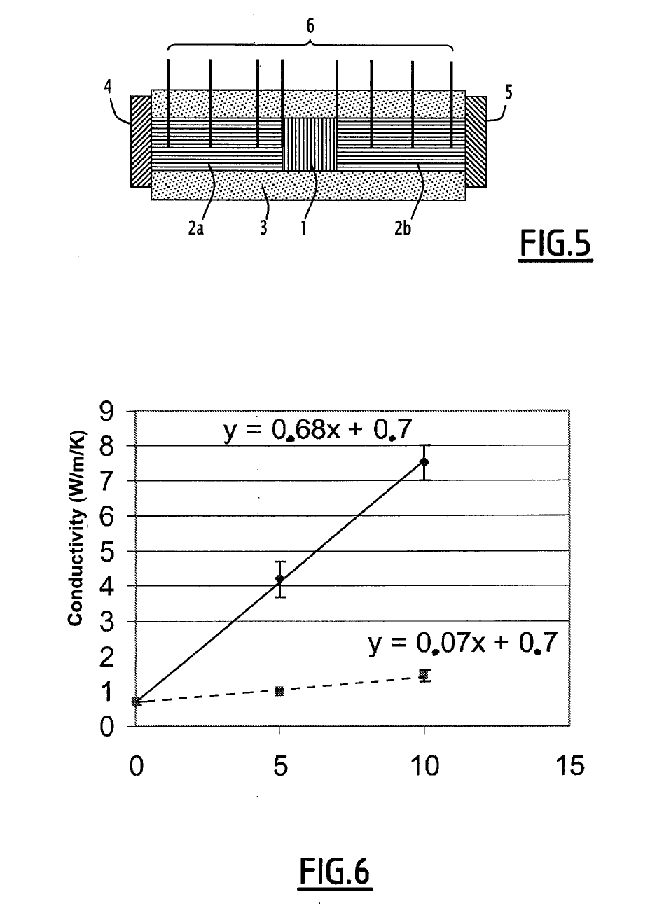

FIG. 6: the radial and axial thermal conductivities of the material obtained according to Example 1 for different contents of graphite.

FIG. 7: the Mg—MgH₂ equilibrium curve enabling the absorption and desorption conditions to be determined.

### EXAMPLE 1

### Preparation of Pellets of MgH₂/ENG

In a suitable leaktight mixer, placed in a glove box under a controlled atmosphere, 47.5 g of activated magnesium hydride powder having an average grain size of 1 to 10 μm, (available from MCP MG Serbien or MCPHy Energy SA) are carefully mixed with 2.5 g of expanded natural graphite powder (ENG, average grain size in the form of particles having a length of a few millimetres (available from SGL Technologies GmbH).

The mixture of powders (50 g), is then poured into the die of a hardened steel pelleting machine also placed in a glove box. The pelleting machine is withdrawn from the glove box in an airtight bag, and placed under a press.

The powder placed in the pelleting machine is compacted by uniaxial compression having an intensity of the order of 1 t/cm² (10⁸ Pa).

Pellets of a grey, compact material, having an appearance close to that of solid graphite and a diameter of 8 cm are recovered which can be handled in the open air for several minutes. Nevertheless, it is preferable to store the composites in a controlled atmosphere in order to avoid any risk of heating up and surface oxidation.

The density of the material in the different pellets obtained was calculated by weighing and measurement of the dimensions. The porosity was calculated from the theoretical and measured densities. The results are shown in FIG. 1.

The pellets have a mechanical strength and a stability with respect to oxidation sufficient to allow them to be handled for the purpose of introduction into the hydrogen tank under normal conditions, that is, in particular, outside the glove box.

The pellets obtained have an exceptional mechanical strength. It is thus possible to machine them, for example in order to adjust the outside diameter to the diameter of the tank, or to pierce holes in order to insert heating elements and thermocouples. Similarly, after repeated hydrogen cycling, neither fissuring nor accumulation of fine powder at the bottom of the tank are observed.

The presence of ENG facilitates the cohesion of the compressed material (FIG. 2). The pellets prepared without ENG are more fragile and do not permit subsequent machining.

### EXAMPLE 2

### MgH₂/ENG Application Tests and Comparison with MgH₂

The properties in the application of hydrogen storage of the material obtained in Example 1 were evaluated and compared with those of powdered activated magnesium hydride.

The diameter of the MgH₂/ENG pellets obtained in Example 1 was reduced from 8 cm to 7 cm by machining. 250 g of the pellets were introduced into a stainless steel cylindrical tank with an inside diameter of 7 cm and a volume of 270 cm³. The tank was equipped with heating means. The tank was then heated to a temperature of 300° C. and placed under 8 bar of hydrogen pressure.

The volume of hydrogen absorbed was recorded by flow meter for a period of 3 hours. The temperature was tracked by means of probes placed at the centre and at the periphery of the tank.

The test was carried out under the same experimental conditions, except for replacing the pellets according to Example 1 with 110 g of activated magnesium hydride powder.

FIGS. 3 and 4 show that the volume of hydrogen absorbed rises from 65 NL with the powder to 170 NL with the pellets (Normal Litres). The compression of the powders therefore makes it possible to more than double the hydrogen storage volume capacity of the material. Comparison with FIG. 5 indicates in addition that charging is more rapid for the compacted material, although the mass of the material and therefore the amount of heat to be evacuated is multiplied by a factor of about 2.5.

Comparison of the temperatures taken at the centre and at the periphery of the tank for the pellets (see FIG. 3) and the powder (see FIG. 4) furthermore shows that the temperature is much more homogeneous within the material according to the invention.

These results demonstrate that the material described makes it possible to improve to a great degree the radial thermal conductivity and the volume storage capacity of the hydrogen storage material.

The thermal conductivity was measured for samples prepared with different contents of ENG. Measurements were made on a conventional continuous duty measuring bench based on the divided bar principle (see FIG. 5). The sample is positioned between two standard parts 2a, 2b and surrounded with insulation 3, the whole being in contact on either side with a hot plate 4 and a cold plate 5. Thermocouples 6 are inserted into the standards and the sample in order to take the temperature according to the distance between the plates.

The average temperature of the sample during measurement is of the order of 30° C. Three compositions comprising 0%, 5% and 10% (by weight of ENG respectively) were tested. To this end, “small bars” were cut out in the plane of the pellet (radial measurements entered in a continuous line in FIG. 6), and along the compaction axis (axial measurements, in dashed lines).

The results are illustrated in FIG. 6 and indicate that for the contents studied, the thermal conductivity is proportional to the ENG content. A very strong anisotropy of behaviour is also observed: the radial conductivity increases very rapidly with the ENG content, while the axial conductivity is affected only a very little by the presence of ENG.

Moreover, the aforesaid material has a low reactivity to air, which makes it much safer to handle and in particular facilitates the charging of the tanks with hydride.

Its very high mechanical strength also permits machining of the pieces in order to adapt them to the geometry of the tanks, for example in order to provide for the passage of heat exchangers. The mechanical strength persists even during cycling under hydrogen, thereby making it possible to avoid the problems of mechanical stress associated with the heaping of the powders and/or decrepitation.

1-12. (canceled)

13. A compacted material comprising magnesium hydride and expanded natural graphite, wherein the magnesium hydride is activated by co-grinding with a transition metal, a mixture of transition metals, a transition metal oxide or an alloy of transition metals.

14. A material according to claim 13, wherein the magnesium hydride is activated by co-grinding with an alloy of centred cubic structure based on titanium, vanadium and a transition metal selected from chromium and manganese.

15. A material according to claim 13 shaped by compaction.

16. A material according to claim 13, comprising from 80 to 99% by weight of magnesium hydride.

17. A material according to claim 13, comprising from 1 to 20% by weight of graphite.

18. A method for preparing a compacted material comprising magnesium hydride and expanded natural graphite, including the steps which consist in:
(i) mixing a magnesium hydride or powdered magnesium with a powdered expanded natural graphite; and
(ii) shaping the mixture by compaction.

19. A method of preparation according to claim 18, additionally comprising a preceding step which consists in activating the magnesium hydride or the powdered magnesium by co-grinding with a transition metal, a mixture of transition metals, a transition metal oxide or an alloy of transition metals.

20. A method according to claim 18, wherein compaction is carried out in a pelleting machine.

21. A method according to claim 18, wherein the shaped material is then machined.

22. A method for hydrogen storage by use of the material according to claim 13.

23. A method for hydrogen storage and release from storage including the steps which consist in:
(a) introducing a material according to claim 13 into a suitable hydrogen tank;
(b) placing the material under hydrogen pressure in pressure and temperature conditions that enable the hydrogen to be absorbed by the material; and
(c) desorbing the hydrogen from the material in pressure and temperature conditions permitting the desorption of the material.

24. A method according to claim 23, wherein the energy released by charging with hydrogen is evacuated by a heat exchanger.
